(19) United States
(12) Patent Application Publication
(10) Pub. No.: US 2007/0064763 A1
(43) Pub. Date: Mar. 22, 2007

(54) Glass melt electrode and method for melting glass or glass ceramic

(76) Inventors: Holger Hunnius, Mainz (DE); Frank Juergen Druschke, Bechtolsheim (DE); Joerg Schollmayer, Mainz (DE); Robert Ruehl, Mainz (DE)

Correspondence Address: STRIKER, STRIKER & STENBY, 103 EAST NECK ROAD, HUNTINGTON, NY, 11743, US

(21) Appl. No.: 11/520,074

(22) Filed: Sep. 13, 2006

(30) Foreign Application Priority Data
Sep. 19, 2005 (DE) 10 2005 044 601.9

(51) Int. Cl. C03B 5/027

(52) U.S. Cl. 373/36; 65/135.7

(57) ABSTRACT

At least two electrodes are mounted in a wall of a melting furnace for melting glass or glass ceramics to supply electric current for additional heating of the melt. Each electrode includes a first section with a heating element and a second section with a cooling device. The first section is assigned to an interior of the melting furnace and the second section is assigned to a side of the wall of the melting furnace facing away from the glass melt. In the method energy is supplied to the glass melt by the electrodes of the present invention, the first section of each electrode is heated with the heating element, and the second section is cooled with the cooling device. Advantageously the heating element is a non-inductive resistor element and the cooling device operates with a cooling liquid.

### BACKGROUND OF THE INVENTION

1. The Field of the Invention

The present invention relates to an electrode for mounting in the wall of a melting furnace for melting glass or glass ceramic, which is called a glass melt electrode, and to a method of melting glass or glass ceramic.

2. Related Art

Tank furnaces are used to produce large amounts of glass or glass ceramic, and especially in automated manufacturing processes. They usually each comprise a lower furnace, an upper furnace, and chambers, in which combustion air is pre-heated. The lower furnace is the actual melt vessel for the glass batch and has the form of a tank with a tank bottom and tank walls, which are about 1 m in height. The upper furnace overarches the lower furnace.

The glass batch is melted in the melt vessel for the glass and the glass is heated and refined. The energy supply occurs predominantly from above the raw materials or the glass batch and/or the glass bath upper surface using burners, whose flames heat the raw material and the glass.

Additional energy is supplied by at least two glass melt electrodes embedded in the wall of the melting furnace, as needed, according to the particular application. The glass melt electrodes supply additional energy by passing a current through the glass raw materials and/or the glass melt, which introduces additional thermal energy. This is possible because glass and glass ceramic are sufficiently electrically conductive at high temperature.

FR 1 212 169 describes an electrode, which preferably has a hairpin-shape or V-shape and which is inserted at those positions in the glass melt, at which the glass is already comparatively cooler. Thus there is a danger that the glass melt solidifies in an insulating layer on the electrode surface and thus interrupts the current flow. This can be avoided by an additional heating of the entire electrode or part of it, which influences the convective glass flows in the glass melt and the temperature of the glass melt.

### SUMMARY OF THE INVENTION

It is an object of the present invention to provide an electrode for mounting in the wall of a melting furnace for melting glass or glass ceramic, with which the production of the glass or glass ceramic products can occur with higher yield, and which can be more quickly built into the wall of the melting furnace, wherein the term “wall” means each wall of the melting furnace or tank, i.e. the bottom wall, side wall, front wall, and covering wall or cover.

Since the glass melt electrodes are mounted in openings in the wall of the melting furnace, escape of glass through these openings must be prevented. For this purpose the electrodes of this type are conventionally cooled within the wall on a side of the electrode facing away from the melt. Cooling the wall of the melt vessel in the vicinity of the openings produces plugs or stoppers made of glass at the openings. These plug or stoppers completely seal the outer side of the melt vessel.

According to the invention the above-described engineering problem can be solved with an electrode for mounting in the wall of a melting furnace for melting glass or glass ceramic material, which has a first section associated with the interior of the melting furnace and a second section associated with a part of the wall facing away from the interior or glass melt, in which the first section is provided with a heating element and the second section is provided with means for cooling.

According to the invention the method for melting glass or glass ceramic in a melting furnace, in which a glass batch and/or a glass melt is supplied energy by means of electrodes mounted in a wall of the melting furnace, comprises heating a first section of the electrode, which is assigned to an interior of the melting furnace, and cooling a second section of the electrode, which is assigned to a part of the wall that faces away from the interior or the glass melt contained in it.

The above-described solution is based on the understanding that the cooling of the glass melt electrode reduces the quality of the melt and decreases the yield of the glass or glass ceramic product that is produced.

A great temperature difference exists between the inner side of the wall and the outer side of the wall of the melting furnace, when glass or glass ceramic material is melted in it. While the temperature of the inner side of the wall is e.g. at 1400° C., the temperature at the outer side is only slightly higher than room temperature, for example 30° C. Thus a large temperature drop occurs over the 50 to 75 cm thick wall of the melt vessel.

If the glass melt electrodes are installed in the openings in the melting furnace or vessel wall and portions of the electrodes are cooled, the cooled portions provide local heat sinks, which cool the glass material located on the glass side edges of these openings.

It has been learned that the local cooling of the glass melt electrodes reduces the quality of the melt, and of course especially when the glass melt is temperature sensitive. Thus cooling leads to undesirable crystallization, which consequently leads to glass defects due to the presence of crystals and to further glass faults, for example schlieren. The qualitative impairment of the glass melt leads generally to a reduced yield during glass production, since the specifications regarding the number and size of the permitted glass defects cannot always be maintained, which is especially true for crystallizable glass, which is further processed to glass ceramic. On the other hand, the cooling is necessarily required in order to prevent the above-described loss of glass from the interior to the outside of the melt vessel.

The essential ground breaking feature of the present invention is the heating of the electrode in the first section associated with the interior or facing the glass melt. Furthermore the second section of the electrode facing away from the glass melt is cooled. No local heat sink, which can cause the above-described glass defects, arises any longer because of the heating of the glass side, so that the yield of the glass or glass ceramic product with the given specifications of permitted glass faults or defects can be desirably increased, because the cooling prevents the loss of glass or glass ceramic through the openings in the wall of the melting furnace.

An additional significant advantage associated with the use of the heating element is that exchange or replacement of electrodes can be performed more rapidly.

The above-described glass plugs or stoppers for preventing the loss of glass melt prevent a rapid removal of the glass melt electrode after lowering the glass level below the electrode level when an outlet in the bottom of the melting furnace is opened. This is the case because the glass adheres to the electrode, on the one hand, and on the other hand adheres rigidly to the inner surface of the opening. As a rule, turning down and then turning off the cooling after the complete or partial (until below the electrode level) emptying of the melt vessel until the heat supplied to the wall releases the glass stoppers or plugs is an effective method for releasing the electrodes. This is attended to as a rule in several hours.

It is also possible to soften the glass stopper within a few minutes by switching on the heating element after outflow of the melt and to take the electrode out of the opening immediately. In this way the installation and removal of the electrode can occur comparatively quickly, which leads to a considerably improvement in productivity.

The above-described possibility for heating the glass plugs by means of the heating element exists especially when the melt vessel is already strongly cooled, i.e. when the heating of the wall is otherwise insufficient to release the plug.

An electrical heating element or an inductively heated heating element can be selected to perform the functions of the heating element. In a simple embodiment the electrical heating element is a non-inductive resistor element. Instead of one heating element of course several heating elements can be used. This can be advantageous because when one heating element fails the entire electrode heating does not stop.

The glass batch and/or the glass melt are in contact with a part of the first section of the electrode when the melt vessel is filled. This part of the first section of the electrode (the head of the electrode) contacting the glass raw materials or the melt is exposed to a high temperature and comprises a thermally stable metal that is resistant to the glass melt. Molybdenum, tungsten, platinum, rhodium, and platinum alloys can be used as the metal for the electrode according to the invention.

It is preferred to use platinum or its alloys, e.g. with rhodium, as the electrode material, especially for glass with a high quality specifications, since platinum and its alloys are largely chemically inert and do not react or attack the glass or glass ceramic melt.

As a rule, the entire electrode is not made of platinum, but only that portion, which contacts the glass melt, in order to reduce the expense connected with using the expensive platinum metal. The additional parts of the electrode can be made from a metal that is not a noble metal, such as steel or a nickel alloy, and are bonded in one piece with the section made of platinum.

Preferably the part of the platinum alloy electrode, which comes into contact with the glass melt, does not comprise platinum, but instead is sheet metal of a thickness of about 0.2 to 5 mm, which is held by means of a supporting body. The supporting body provides the required stability and comprises a fire-resistant material, for example a ceramic material, which is economical in comparison to platinum. The platinum sheet metal thus provides the heat flow surfaces for heating the glass batch and/or the melt with the electrode, i.e. the heat flows into the melt through this platinum casing or jacket.

In an actual embodiment of the invention at least a part of the platinum metal casing or jacket (the metallic coating on the supporting body) functions as the heating element. The heat flow circuit, which provides for the heating of the first glass-side section of the electrode, comprises suitable electrical conductors and connectors. Since this first section comes into thermal contact with the melt via the metallic cap, which is similarly heated. In this way the local temperature drop is compensated or over-compensated by the water-cooled glass melt electrode.

Alternatively or additionally a non-inductive resistor element, which comes into thermal contact with at least one part of the metallic cap, can function as the heating element for the metallic cap. Because of that the heat flow circuit can be decoupled from the electrode circuit that supplies current to heat the melt.

There are a number of different ways to provide the heating element as a non-inductive resistor element. The non-inductive resistor, for example, can be a heating coil or a heating cartridge.

In a preferred embodiment the heating element is a heating module, so that at least a part of the heating element is replaceable. This permits easy maintenance and repaid exchange in case of repair.

The exchangeable embodiments have the advantage when the heating element is exclusively required in order to permit a more rapid disassembly of the electrode, which is especially the case when the melt is somewhat temperature sensitive. In this case the heating element can release the glass plug as needed by heating the first section of the electrode, and subsequently the heating element is removed. The electrode is then removed and the exchangeable module withdrawn to release the glass plug at the other electrode.

The second section of the electrode according to the invention can have an electrode holder. The electrode holder mechanically holds the electrode and provides the connection for current supply. A cooling unit, especially with means for water-cooling, is provided to guarantee that the electrodes embedded in the wall of the melting furnace can form the glass plugs or stoppers.

A fluid cooling, which is known in principle for the glass melt electrodes, includes supplying a cooling medium through an inner pipe of a double-walled electrode holder and conducting the cooling medium away through an outer pipe of the double-walled electrode holder. Water or a gas, generally air, can be used as the cooling medium.

In a preferred embodiment the second section of the electrode also has a heating element. This heating element is arranged close to the glass plugs or stoppers to prevent the loss of glass from the melt and permits an especially rapid softening of the glass plugs or stoppers for disassembly of the electrodes for maintenance purposes.

The glass melt electrode equipped with a heating element has a current supply circuit for the electrodes and another current supply circuit from the heating element. Preferably the current supply circuits are galvanically separated from each other. The galvanic separation in combination with the exchangeable heating element facilitates the disassembly or assembly of the entire heating device comprising the heating element, the electrical connecting elements and the conductors. In this way the heating can be built in as needed subsequently or shortly prior to exchange of the electrodes. It is also possible in this way to provide a single heater for maintenance purposes, which is mounted in the different electrodes of the melting furnace one after the other, in order to release or demount them from the wall. In this way only one heater is required for this purpose, whereby this heating procedure can be conducted with minimal costs.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a diagrammatic cross-sectional view through a glass melting furnace with two electrodes according to the invention installed in the wall of the glass melting furnace;

FIG. 2 is a partially cross-sectional, partially side view of a first embodiment of a glass melt electrode according to the present invention;

FIG. 3 is a schematic side view of the electrode shown in FIG. 2;

FIG. 4 is a partially cross-sectional, partially side view of a second embodiment of a glass melt electrode according to the present invention;

FIG. 5 is a partially cross-sectional, partially side view of a third embodiment of a glass melt electrode according to the present invention;

FIG. 6 is a partially cross-sectional, partially side view of a fourth embodiment of a glass melt electrode according to the present invention;

FIG. 7 is a partially cross-sectional, partially side view of a fifth embodiment of a glass melt electrode according to the present invention;

FIG. 8 is a partially cross-sectional, partially side view of a sixth embodiment of a glass melt electrode according to the present invention; and

FIG. 9 is a partially cross-sectional, partially side view of a seventh embodiment of a glass melt electrode according to the present invention.

### DESCRIPTION OF THE PREFERRED EMBODIMENTS

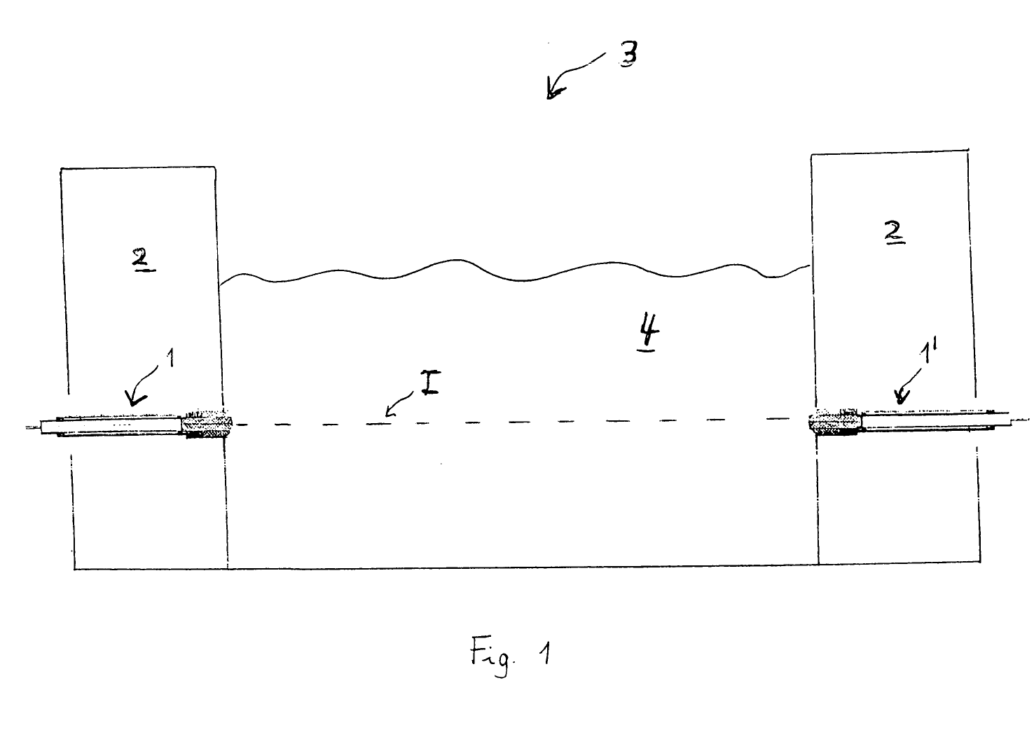

FIG. 1 shows a melting furnace 3 with two electrodes 1,1′. The electrodes 1,1′ are embedded in the wall 2 of the melting furnace 3 and are used for heating the melt 4. The electrodes 1, 1′ are acted on to produce an electrical current with an intensity I in the melt 4, which heats the melt 4. In a first approximation the current flows along the horizontal dashed line shown in FIG. 1.

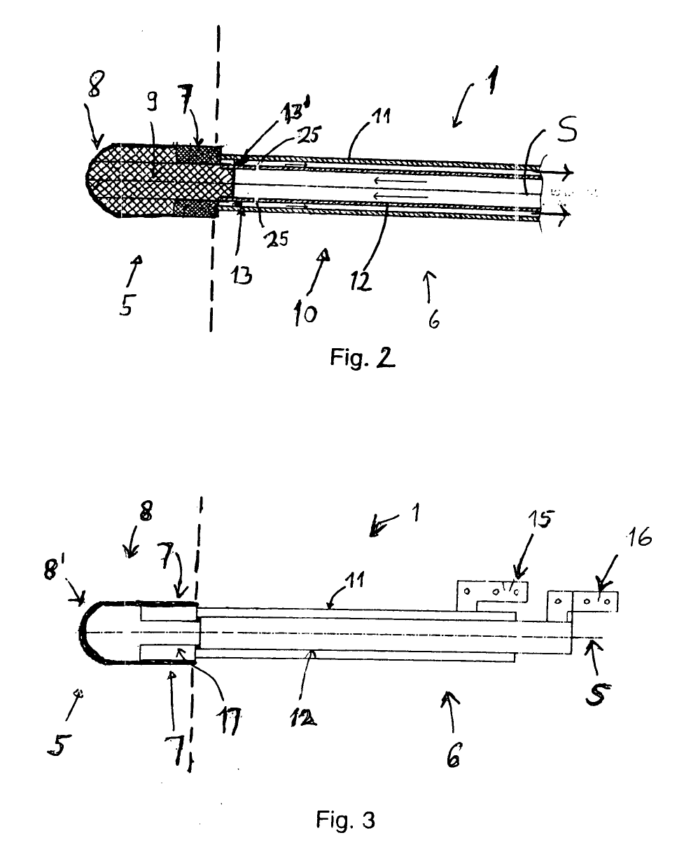

FIG. 2 shows a partial cross-section through an electrode 1 according to the invention in a side view with a cross-section through the symmetry axis S of the cylindrically symmetric electrode. The electrode 1 is about 75 cm long and has a maximum outer diameter of about 45 cm.

The vertical dashed line in FIG. 2 divides the glass melt electrode into a first section 5 on the left of FIG. 2 and a second section 6 on the right of FIG. 2. As shown in FIG. 1, the first section 5 faces the melt 4 when the electrode 1 is installed or embedded in the wall 2 and this assignment is associated its function. This assignment results from the fact that the electrical current flowing through the melt 4 originates from the first sections 5 of the electrodes 1,1′ (FIG. 1).

The first section 5 has a metallic cap 8 at the left end of the horizontal symmetry axis S. The cap 8 is electrically connected with a heating element 7. A supporting body 9 made of a fire-resistant material, namely a ceramic material, holds the cap 8. A part of the cap 8, which comes in contact with the glass melt, is made of a platinum sheet of thickness from 0.2 to 5 mm. The heating element has a cylindrical heating surface and comprises a non-inductive resistor.

The supporting body 9 is connected with an electrode holder, which comprises an inner pipe 12 and an outer pipe 11, which are separated from each other by insulators 13, 13′. Unshown electrical conductors provide the cap 8 with electrical current for heating the melt 4 and provide the heating element 7 with electrical current for heating the first section 5.

The electrode current for heating the glass batch or the melt 4 flows through the outer pipe 11. The power dissipated in the melt 4 amounts of 10 kW. The voltage applied to the inner pipe 12 for heating purposes is about 1.2 V and the current is from 1000 to 2000 A.

The second section 6 is cooled by a cooling medium that flows through the inner pipe 12 and then out again through the outer pipe 11 after passing through the opening 25, which is arranged near the first section 5. The inflow and outflow lines connected to the inner and outer pipes are not shown in FIG. 2.

The inner and outer pipes 11, 12 are provided with electrical insulation as needed, so that an undesirable current flow between inner and outer pipes cannot occur through the cooling fluid. When gases are used as cooling fluids, a special insulating material is not necessary, since gases are not electrically conductive.

FIG. 3 is a side view of an electrode 1 according to FIG. 2, which has the metallic cap 8 on the first section 5. This cap 8 includes a region 8′ acted on by the glass melt, which is made of platinum, and also the metallic heating element 7 with the heating surface. The heating surface is thus a part of the metallic cap 8. The regions 8′ and 7 are made in one-piece in the cap 8. The cooling is illustrated in FIG. 2 and not shown in detail in FIG. 3 in order to make the figure easier to read.

The metallic cap 8 is electrically connected with the outer pipe 11. A common electrical connector 15 is provided for the circuit for heating the glass melt and the circuit for heating the first section 5 of the electrode 1. The electrical current for the additional heating, also for heating the first section 5, travels from the connector 15 through the outer pipe 11, the heating surface of the heating element 7, the cylindrical electrical conductor 17, and the inner pipe 12 to the second electrical connector 16. In this embodiment a non-inductive resistor provides the heating surface, which is in thermal and electrical contact with the metallic cap 8.

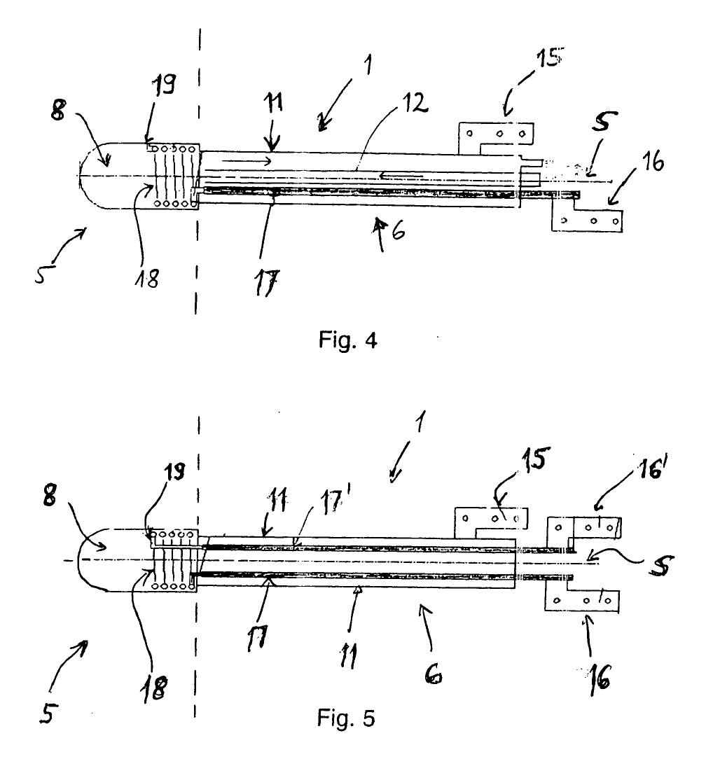

FIG. 4 shows an additional embodiment of the glass melt electrode 1 according to the invention, in which a heating coil 18 functions as the electrical heating element for the cap 8 in contrast the embodiment shown in FIG. 3. The associated current flows from the common electrical connector 15 via the outer pipe 11 to the contact 19, and then through the heating coil 18 and to the conductor 17 to the electrical connector 16. Also the cooling features have been omitted here to make the figure easier to read. The cooling occurs by means of a supply pipe 12 that is open at its end and that is inserted in the outer pipe 11.

FIG. 5 shows an embodiment of the glass melt electrode 1, which differs from the embodiment shown in FIG. 4 in that it has electrically separated circuits for heating the melt and for heating the first electrode section 5. For this purpose the heating coil 18 is connected electrically with the electrical connectors 16, 16′ by means of two electrical conductors 17, 17′. This circuit for heating the first electrode section 5 is electrically separate from the circuit for heating the melt. The current for heating the melt flows from the connector 15 via the single pipe 11 to the cap 8, and from there through the melt to another glass melt electrode 1′, which is not shown in FIG. 5. The cooling occurs in a manner similar to FIG. 4 and is not shown in FIG. 5.

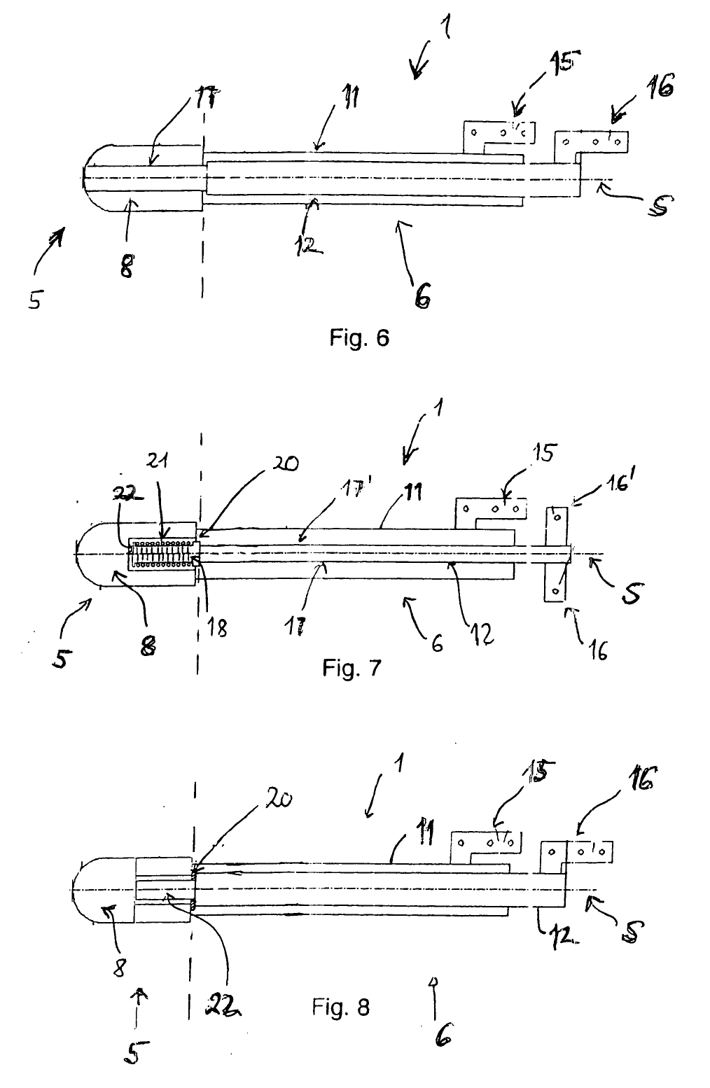

In the embodiment according to FIG. 6 the heating of the first electrode section 5 occurs by means of the entire metallic cap 8, which is formed as a non-inductive heating element. For this purpose current is supplied to the outermost left end of the cap 8 from the connector 16 via the inner pipe 12 and the cylindrical conductor 17, which then flows to the connector 15 through the cap 8 and the outer pipe 11. Inflow and outflow of the cooling medium occurs through the inner and outer pipes in a manner similar to FIG. 2.

The heating element is exchangeable or replaceable in the embodiment of the glass melt electrode shown in FIG. 7. The first electrode section 5 is provided with a central cavity 20, in which a heating module 21 is mounted. The heating module 21 comprises a cylinder 22, which is surrounded by a heating coil 18. Alternatively one or more heating cartridges can be used instead of the heating coil 18. Conductors 17, 17′ electrically connect the heating coil 18 with the connectors or terminals 16, 16′. The conductors 17, 17′ are exchangeable so that both the circuit for the heating module 21 and the heating element itself are also exchangeable. The circuit originating from the connector 15 for heating the melt is galvanically separate. The cavity 20 is sealed from the inner pipe 12, which performs the cooling in the same manner as in FIG. 2.

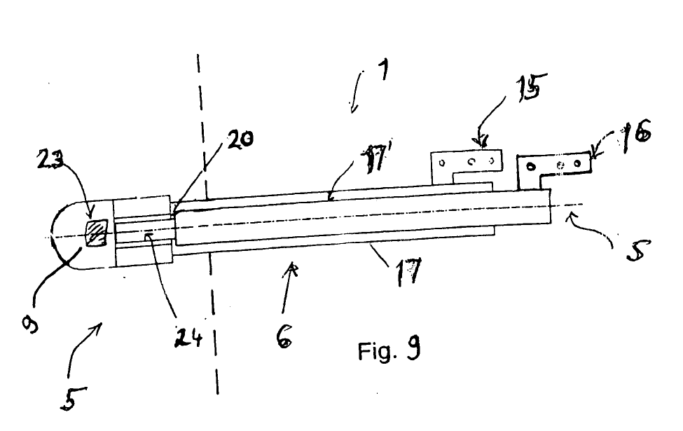

The glass melt electrode 1 according to FIG. 8 is formed with a heating module in a manner similar to the embodiment shown in FIG. 7. However here instead of the heating coil the cap 8 is supplied with current by means of a plug 22, which is supplied with current via the inner pipe 12, so that the heating of the first electrode section 5 occurs by means of an non-inductive heating of the cap 8. The plug 22 and the inner pipe 12 can be disconnected or removed from the electrode 1 as need. The cavity 20 is sealed from the inner pipe 12. The cooling takes place in a manner similar to FIG. 2.

FIG. 9 illustrates a modular embodiment of the glass melt electrode 1, whose heating element has an inductively heated metal block 23 arranged in an otherwise non-conductive heatable supporting body 9, which is made of a ceramic material. In operation a cylindrical module 24, which has an unshown, preferably water-tight, encapsulated coil for producing a magnetic field, is inserted in the central cavity 20 of the supporting body 9. The coil in the module 24 that generates the magnetic field is supplied with current by means of the connector 15 and 16 via the conductors 17,17′. A magnetic filed is produced in operation by flowing current through the coil, which couples with the metal block 23 and then heats it. The module 24 is replaceable or exchangeable, and can be pushed to the right as needed along the symmetry axis S and is taken from the opening in the wall of the melt vessel. The cooling of the second section facing away from the glass melt occurs analogously to the cooling in the embodiment of FIG. 2 by means of the outer and inner pipes 11,12.

When the electrodes are operated without the module 24, the module is replaced by a simple inner pipe, which is provided with openings or is open on its side facing the furnace. The cooling fluid is supplied through the inner pipe and leaves the electrode body by means of the outer pipe. The module 24 can replace the inner pipe, even during operation of the glass furnace, as needed.

The disclosure in German Patent Application 10 2005 044 601.9 of Sep. 19, 2006 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in an electrode for installation in a wall of a melting furnace for melting glass or glass ceramic and to a method of melting glass or glass ceramic in which energy is partially supplied by the electrode, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. An electrode for mounting in the wall of a melting furnace for melting glass or glass ceramics, said electrode comprising
a first section including at least one heating element; and
a second section including means for cooling;
wherein the first section is assigned to an interior of the melting furnace and the second section is assigned to a side of the wall of the melting furnace facing away from the interior of the melting furnace.

2. The electrode as defined in claim 1, wherein the at least one heating element comprises an electrical heating element or an inductively heatable heating element.

3. The electrode as defined in claim 2, wherein the at least one heating element comprises a non-inductive resistance element.

4. The electrode as defined in claim 3, wherein the first section comprises a metallic cap at least in a region coming in contact with a glass melt in the interior of the melting furnace when the glass melt is present.

5. The electrode as defined in claim 4, wherein said at least one heating element is at least a part of the metallic cap.

6. The electrode as defined in claim 4, wherein the non-inductive resistance element is in thermal contact with said metallic cap.

7. The electrode as defined in claim 3, wherein the non-inductive resistance element comprises a heating coil or a heating cartridge.

8. The electrode as defined in claim 1, wherein the at least one heating element is modular and/or exchangeable.

9. The electrode as defined in claim 1, wherein said second section comprises an electrode holder.

10. The electrode as defined in claim 1, further comprising an electric circuit for supplying current for heating a glass melt and an electrical circuit for supplying current to the at least one heating element, and wherein said electric circuit for supplying current for heating the glass melt and said electrical circuit for supplying current to the at least one heating element are galvanically separated.

11. The electrode as defined in claim 1, wherein said means for cooling comprises means for supplying a cooling fluid.

12. The electrode as defined in claim 11, wherein the cooling fluid is water.

13. A method of melting glass or glass ceramic in a melting furnace, said method comprising the steps of:
a) supplying energy to a glass batch and/or a glass melt in the melting furnace by means of electrodes mounted in a wall of the melting furnace;
a) heating a first section of one of the electrodes, said first section being assigned to an interior of the melting furnace; and
b) cooling a second section of said one of the electrodes, said second section being assigned to a part of the wall that faces away from the glass batch and/or the glass melt.

14. The method as defined in claim 13, wherein the heating of the first section occurs electrically.

15. The method as defined in claim 13, wherein the cooling of the second section occurs by passing a cooled fluid through at least a part of the second section.
